(19) United States
(12) Patent Application Publication
(10) Pub. No.: US 2002/0077941 A1
(43) Pub. Date: Jun. 20, 2002

(54) Method and apparatus for documentation, analysis, auditing, accounting, protection, registration, and verification of trade secrets

(76) Inventors: R. Mark Halligan, Naperville, IL (US); Richard Weyand, Naperville, IL (US)

Correspondence Address: Welsh & Katz, Ltd., Jon P. Christensen, 22nd Floor, 120 South Riverside Plaza, Chicago, IL, 60606, US

(21) Appl. No.: 09/757,206

(22) Filed: Jan. 9, 2001

Related U.S. Application Data
(60) Provisional application No. 60/175,523, filed on Jan. 11, 2000.

(51) Int. Cl. G06F 17/60

(52) U.S. Cl. 705/30

(57) ABSTRACT

Methods and apparatus for documentation, analysis, auditing, accounting, protection, registration, and verification of trade secrets are disclosed. Information relating to a trade secret, including the trade secret's identification, description, keywords, source, creation date, creation location, value, depreciation method, threat of theft, measures for protection, patentability, estimated life expectancy, the type of trade secret, combination analysis, and data associated with the six factors of a trade secret as set forth in Section 757 of the First Restatement of Torts, is entered into the computer system. Additional information concerning the management of the trade secret, including legal reviewer, legal review date, legal review schedule, business reviewer, business review date, business review schedule, validity status, source status, and licensing status, is entered into the computer system. Further information concerning the company, such as company locations, company groups, departments, and divisions and their hierarchical relationships, and further information concerning the employees, including locations employed, and group, department, and division employed, is also entered into the computer system. The computer system archives and timestamps the data entered. The system performs analysis of the data, producing graphs and reports for the purposes of documentation, analysis, auditing, accounting, and protection of the trade secrets. These analyses include analyses of the values of trade secrets, the ranking of trade secrets, the adequacy of security measures, the exposure of employees to trade secrets, and other analyses relevant to the protection of trade secret assets. The computer system registers the trade secret with a computer system operated by a trusted third-party through the use of unique identification codes. The third-party computer system records the existence of the trade secret and the associated unique identification codes without receiving any decodable trade secret information. The third-party computer system issues a trade secret certificate, which can be used by the trade secret originating company and other firms to verify the existence, ownership, and registration date of the trade secret. The unique identification codes maintained by the trusted third-party can be used to verify the trade secret data at a later date.

### FIELD OF THE INVENTION

The subject patent is in the area of accounting methods, specifically, accounting for trade secret intellectual property assets. It is intended to be used primarily for documentation, analysis, auditing, accounting, protection. and determining the value of trade secret intellectual property, ensuring that appropriate steps are taken to protect against theft of the trade secret intellectual property, and providing evidence to support the identification of trade secret intellectual property assets for the business, financial, banking, accounting, insurance, securities and legal professions.

### BACKGROUND OF THE INVENTION

This invention relates generally to the field of accounting methods and more particularly to methods and apparatus for documentation, analysis, auditing, accounting, protection, registration, and verification of trade secrets.

Trade secret is a recognized intellectual property right under United States laws, and also under the laws of many foreign countries. The other intellectual property protection provided to ideas is patent protection. Patent protection, unlike trade secret protection, requires disclosure. In an industrial economy, patents were the favored intellectual property right. In the information economy, disclosure of the information required to obtain a patent is increasingly viewed as disadvantageous. There has therefore been growth in the use of the trade secret protection to safeguard companies' intellectual property.

The growth of information technology has been accompanied by an increase in employee turnover and the use of temporary workers. Greater transferability of job skills, the more rapid pace of product development and obsolescence, and the rise of telecommuting have made employees more mobile. At the same time, trade secrets are more likely to be information stored in computers than mechanical processes embodied in production machinery, making them more portable. With increased employee mobility and trade secret portability, there is now a greater risk of the theft of trade secrets. In this environment, litigation alleging theft or misappropriation of trade secrets is growing.

Allegations of theft or misappropriation of trade secrets are difficult to prove, however. Unlike patents, trademarks, or copyrights, there is no disclosure. There is no equivalent to the United States Patent and Trademark Office or the United States Copyright Office for trade secrets, nor is there any equivalent to the patent examiner or trademark examiner. No equivalent to the patent certificate or trademark certificate or copyright registration is issued. There is no reliable independent third-party proof of the existence of the trade secret.

Information technology has gradually made this lack of proof much worse, because trade secret information is increasingly maintained in computer files. Computer files are easier to forge than hard-copy files. It is also easier to manipulate the timestamps of computer files than it is to tamper with hard-copy signed and dated documents.

One of the inventions we claim is a system that provides third-party proof of the existence, ownership, contents, and other information relating to a trade secret.

The lack of structure in the documentation of trade secrets is a problem in many companies. Indeed, companies often have little documentation in place to prove the existence of trade secrets developed over long periods at considerable expense. Once misappropriation is alleged, the documentation of the company's trade secrets must be undertaken within the time pressure of a litigation schedule, as an after-the-fact process. One of the inventions we claim is a method of gathering, storing and managing the documentation of trade secrets.

In addition to collecting information on the company's trade secrets, an evaluation should be done to determine whether the trade secret is likely to meet the tests applied by the courts. In the United States, Section 757 of the First Restatement of Torts set forth six factors for evaluating the existence of a trade secret to assist the courts in adjudicating trade secret cases. One of the inventions we claim is a method of using the six factors to document, weight, and evaluate the existence of a trade secret and measures to protect the trade secret.

One of these factors is the security provided to protect the trade secret. Security measures may range from simply locking the building every night to elaborate combinations of measures, including round-the-clock security guards, alarm systems, safes or locking cabinets, employee agreements, badges for all employees and visitors, and other measures. Given the lack of structure in the documentation of trade secrets in many companies, it is not surprising that, in the evaluation of the adequacy of security measures taken to protect the trade secret, the court often finds the security measures taken were inadequate and, as a consequence, denies protection. One of the inventions we claim is a method of documenting and evaluating the security measures in place to protect trade secrets.

Security of trade secrets is also threatened by the mobility of employees within the company. It can be difficult to determine to what trade secrets an employee may have been exposed during an employment that included time spent at multiple levels, in multiple organizations within the company, and at multiple locations. This becomes an issue in litigation, in which one must prove access to the trade secret in order to bring a claim of misappropriation. One of the inventions we claim is a method of determining from trade secret and employee information to which trade secrets an employee has been exposed.

Trade secret information often changes over time. The trade secret may become widely known through independent discovery, become obsolete through the advance of the technology, or simply prove no longer useful in the company's changing line of business. Conversely, the trade secret may become more valuable as technology changes or as the company's business efforts are redirected to take greater advantage of the trade secret. The time-dependent nature of trade secret information makes it even more likely that mishandling, poor documentation or inadequate security measures will put the existence of trade secret protection at risk.

Additionally, the trade secret may be modified, improved, and enhanced over time, providing greater value to the company in return for a further investment of time, effort, and money in development of the trade secret. One of the inventions we claim is a system to track modifications, improvements, and enhancements to trade secrets over time.

Another problem with existing methods is the failure to account for negative know-how trade secrets. Often, knowing what does not work is as valuable, if not more valuable, than knowing what does work. One of the inventions we claim is a system for accounting for negative know-how trade secrets.

There is a need for a system to aid in the documentation, analysis, auditing, accounting, and protection of trade secrets. Nevertheless, there is no system in the prior art to provide the unique methods required to document trade secrets, aid in the evaluation of the six factors as applied to the trade secret, record the security measures taken to protect the trade secret, aid in the evaluation of the adequacy of those measures, track the exposure of employees to trade secrets, and perform other such documentation and analysis as provided by the current invention. Computer-assisted systems from various manufacturers provide rudimentary accounting methods for patents, trademarks, and copyrights (e.g.: Computer Packages Inc., Intellectual Property Network, Intellectual Property Online Ltd, Manipulate Systems, Master Patent System), but not for trade secrets. Expensive and incomplete manual methods and in-house procedures that do not embody the instant invention constitute the present state of the art for the protection of trade secret intellectual property.

Further, there is a need for a third-party mechanism to provide verification of the existence, ownership, contents, and other information relating to a trade secret, without requiring disclosure of the trade secret itself. Various methods have been devised to provide open and reliable third-party verification of documents (cf. U.S. Pat. Nos. 5,136,646, and 5,136,647 and their respective references), but these methods have not been applied to the specific needs of verification of the existence, ownership, contents, and other information relating to trade secrets, nor have they been integrated with the methods required for documentation, analysis, auditing, accounting, and protection of trade secrets.

Accordingly, it is an object of this invention to provide improved methods and means for documentation, analysis, auditing, accounting, and protection of trade secrets, including contemporaneous documentation, weightings of the six factors, valuation, depreciation, and accounting methods, maintenance of review procedures, and collection, archival, and viewing of other files required to document the trade secret.

It is a further object of this invention to provide improved methods of analyzing the security measures applied to protecting trade secrets, including assessing the appropriateness of security measures in response to security threats, correlating employee data with trade secret data to document employee exposure to trade secrets, tracking employee confidentiality agreements, and automating periodic emails to employees reinforcing their confidentiality obligations.

It is a further object of this invention to provide open and reliable third-party registration and verification of the existence, ownership, contents, and other information relating to trade secrets, including providing on-line mechanisms for timestamping, datestamping, certifying, and authenticating the trade secret data entered into the system through the use of a trusted third party system, and providing an on-line mechanism for recording and verifying the transfer of ownership or licensing of a trade secret.

### SUMMARY OF THE INVENTION

These and other objectives of the system are accomplished by providing a system in which selected data and other information about the trade secret is collected and characterized and entered into a specialized database with certain unique functions. The system includes a method and apparatus for protecting a trade secret. The method includes the steps of applying a plurality of generally accepted legal criteria to the content of the trade secret, assigning a value under each criterion and generating one or more metrics from the assigned values through the use of logical and mathematical processes, thereby allowing the comparison of results with predetermined threshold values.

The initial data collection takes the form of a “trade secret application”, in which the applicant provides information, including the name of the trade secret, keywords associated with the trade secret, the company location where the trade secret was created, and the applicant's name. The applicant may also provide information about the estimated values of the six factors of a trade secret, such as on a 1 to 5 scale, the estimated level of the security threat to the trade secret, such as on a 1 to 5 scale, the estimated level of the security measures taken to protect the trade secret, such as on a 1 to 5 scale, and other data and information.

The trade secret application data so entered may be presented by the system to another user of the system, this user being an attorney or attorney's clerk known as the legal reviewer, who may review the application and provide additional or amended information. In addition to amending or adding any information listed above, the legal reviewer may add information, including information about the patentability of the trade secret, the review status and review level of the trade secret, the estimated life expectancy of the trade secret, and the type of trade secret.

The trade secret so entered may be presented by the system to another user of the system, this user being a business reviewer, who may review the application and provide additional or amended information. In addition to amending or adding any information listed above, the business reviewer may add information, including information about the estimated value and depreciation method of the trade secret.

Additional information about the company may be entered into the system, including information about the company's locations, its security methods, its organizational structure, including hierarchical structure of groups, departments and divisions, or other hierarchy.

Additional information about the company's employees may be entered into the system, including information about the groups, divisions and departments in which each employee was employed and over what periods, which locations in which the employee was employed and over what periods, whether and when the employee has signed a confidentiality agreement, whether and when the employee was emailed periodic email reminders of his or her confidentiality obligations, and whether and when the employee received this email.

Once data is entered, various analyses may be requested of the system to be performed on the data. These analyses include:

Calculating various weightings of the six factors for each trade secret.

Calculating a value for the security factor for each trade secret.

Calculating a value for the security threat to each trade secret.

Calculating the net present value of each trade secret or any list of trade secrets.

Displaying the net present value as a function of time for any trade secret or any list of trade secrets.

Searching all of the trade secrets in the system for various characteristics according to specified search criteria.

Searching all of the trade secrets in the system for potential duplicates to a given trade secret.

Calculating the ratios and other logical and mathematical values from various values associated with the trade secret and other data and displaying and printing the results in various formats.

Providing selected data, analysis, and record-keeping for the business, financial, banking, accounting, insurance, securities, and legal professions.

Once data has been entered into the system, the resulting trade secret application, together with one or more identification codes providing unique fingerprint identification of the trade secret, such as secure one-way hash codes or other means, is transmitted to a trusted third-party computer system for recording. The trusted third-party computer system archives the unique identification codes, the date and time, and issues a trade secret certificate with a unique trade secret identifier. The trusted third-party system, provided by the inventors or their assigns or licensees, may maintain indefinitely the archive, which we call the trade secret directory, of all trade secrets, their dates and time, and their unique identification codes, allowing verification of said trade secrets at any later time. The trusted third-party system may also provide a means for recording modifications, improvements, and enhancements to trade secrets, and the dates and times of the modifications, improvements, and enhancements, allowing verification of said modifications, improvements, and enhancements at any later time. The trusted third-party system may also provide a means for recording the sale, purchase, license, assignment, and other transfer of ownership or use rights of any trade secret, and allowing verification of said transfer and rights at any later time.

### BRIEF DESCRIPTION OF THE DRAWINGS

FIG. 1 is a block diagram of a trade secret accounting system in accordance with an illustrated embodiment of the invention;

FIG. 2 is a flow chart of processing steps that may be used by the system of FIG. 1 for entering data and assigning an application identifier to a trade secret;

FIG. 3 is a flow chart of processing steps that may be used by the system of FIG. 1 for treatment of security measures;

FIG. 4 is a flow chart of processing steps that may be used by the system of FIG. 1 for validating the existence of a trade secret;

FIG. 5 is a flow chart of processing steps that may be used by the system of FIG. 1 for analysis of employee data;

FIG. 6 is a flow chart of processing steps that may be used by the system of FIG. 1 for analysis of trade secret value;

FIG. 7 is a flow chart of processing steps that may be used by the system of FIG. 1 for splitting a database of trade secret information;

FIG. 8 is a flow chart of processing steps that may be used by the system of FIG. 1 for merging trade secret data;

FIG. 9 is a block diagram of a registration system that may be used with the system of FIG. 1;

FIG. 10 is a flow chart of processing steps that may be used by the system of FIGS. 1 and 9 for registering a trade secret;

FIG. 11 is a flow chart of processing steps that may be used by the system of FIGS. 1 and 9 for checking database integrity;

FIG. 12 is a block diagram of processors of the accounting digital computer of FIG. 1; and

FIG. 13 is a block diagram of processors of the registration digital computer of FIG. 9.

Appendix I is a technical specification describing the functionality of the hardware and software of illustrated embodiments of the invention.

### DETAILED DESCRIPTION OF THE INVENTION

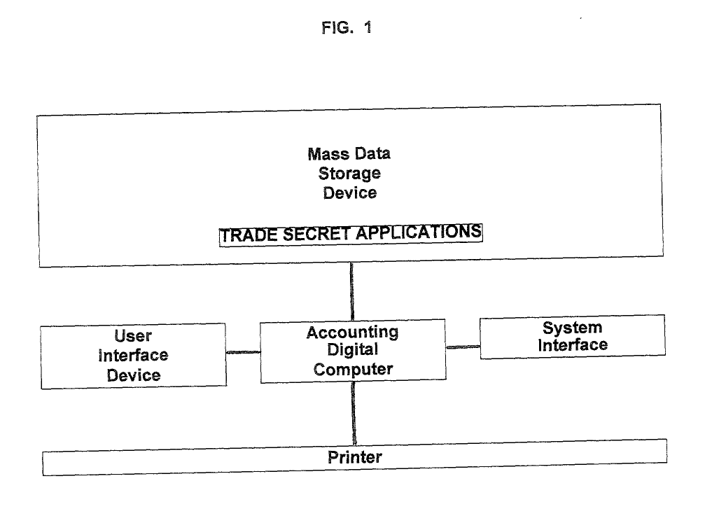

FIG. 1 is a generalized block diagram illustrating the structure of a specific computer system for implementing the invention for documentation, analysis, auditing, accounting, and protection of trade secrets. In the context of this invention, this computer system is called the trade secret accounting system, or the accounting system.

FIG. 1 illustrates a means for data processing, called a digital computer, connected to one or more means for entering the data and displaying the data and the results of searches and calculations, called a user interface device. The user interface device may be, but is not limited to, any number and combination of the following, their equivalents, replacements, or improvements:

A directly connected monitor and keyboard.

A directly connected computer terminal.

A directly connected personal computer.

A computer terminal connected via a modem over telephone lines.

A personal computer connected via a modem over telephone lines.

A terminal connected via one or more local or wide area networks, including the Internet, intranet, private virtual network, satellite link, or other means.

A personal computer connected via one or more local or wide area networks, including the Internet, intranet, private virtual network, satellite link, or other means.

A terminal connected to another computer system, which is then connected to the described system via direct connection, a modem over telephone lines, or one or more local or wide area networks, including the Internet, intranet, private virtual network, satellite link, or other means.

A personal computer connected to another computer system, which is then connected to the described system via direct connection, a modem over telephone lines, or one or more local or wide area networks, including the Internet, intranet, private virtual network, satellite link, or other means.

A document scanner, connected via any of the above means.

Speech recognition device, connected via any of the above means.

Holographic or other projection device, connected via any of the above means.

Inductive neural pickup device, connected via any of the above means.

Direct optical nerve induction device, connected via any of the above means.

At least one means for storing the data entered into the system, as well as the programs required to implement the system, and the results of searches and calculations of the system that may be stored for later use or display, called a mass data storage device, is provided. This mass data storage device may be, but is not limited to, any combination of the following, their equivalents, replacements, or improvements:

Magnetic memory hard disk drive.

Magnetic memory flexible (floppy) disk drive.

CD-ROM (Compact Disc-Read Only Memory) drive.

FLASH-programmable ROM device or devices.

A molecular storage device consisting of data storage by the means of manipulating the structures of molecules within the device.

A means for printing out data, displays, and the results of searches and calculations, called a printer, may be provided. The printer may be, but is not limited to, any combination of the following, their equivalents, replacements, or improvements:

A directly connected printer.

A printer connected via a modem over telephone lines.

A printer connected via one or more local or wide area networks, including the Internet, intranet, private virtual network, satellite link, or other means.

A printer connected to the user input device.

An e-book, an electronic device for the display of downloaded text and data.

A bionic memory implant device, downloaded via any of the above means.

One or more means for connecting the system into other computer systems, called system interfaces, may be provided. A system interface may allow the system to input and output data (user interface functions), to print to one or more devices (printer functions), and to store and retrieve data (mass data storage functions) to and from another computer system that may provide some or all of the user interface functions, printer functions, or mass data storage functions of the system. A system interface may be implemented via direct connection, a modem over telephone lines, the use of removable storage media, or one or more local or wide area networks, including the Internet, intranet, private virtual network, satellite link, or other means. In particular, a system interface is the preferred method for connecting the accounting system to the registration system, described later in this description.

In this document, ‘processor’ means a device capable of performing the steps of the specific process under discussion, such as indexing, registration, or communication. This is to be distinguished from the casual use of the term ‘processor’ in the computer field to refer to a single and distinct Central Processing Unit (“CPU”). In particular, various embodiments of the instant invention may use one CPU within the accounting system to perform the steps of each of the processors contained therein (e.g., within a multiprocessing environment), or one CPU within the accounting system to perform the steps of a plurality of the processors contained therein, or multiple CPUs to perform the steps of a single processor contained therein, or a combination of these.

It should be evident to those skilled in the art that the digital computer and its user interface, storage, and printing devices, and its system interfaces are an underlying technology for the implementation of the system, and the implementation of each of these aspects of the underlying technology are independent of the invention described.

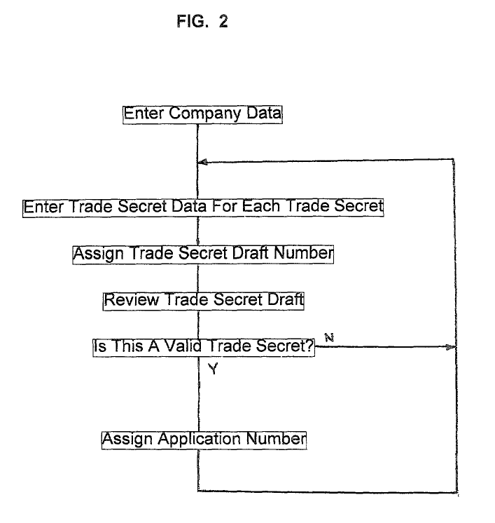

FIG. 2 provides a detailed flow diagram illustrating a methodology and structural flow for a specific embodiment of the instant invention. As illustrated, the data concerning trade secrets is entered into the accounting system. A listing of typical trade secret data that may be entered into the accounting system is provided as an example as Table A.

TABLE A
EXAMPLE OF TRADE SECRET DATA

```
Name Of The Trade Secret
Date The Trade Secret Was Created
Date The Trade Secret Application Was Entered
Name Of The Trade Secret Applicant
Originating Group/Department/Division For The Trade Secret
Locations Where The Trade Secret Is Or Was Created
Locations Where The Trade Secret Is Or Was Stored
Locations Where The Trade Secret Is Or Was Used
Locations Where The Trade Secret Is Or Was Accessible
Keywords Associated With The Trade Secret
Description Of The Trade Secret
Values For The Six Factors Of A Trade Secret:
    Inside Knowledge
    Outside Knowledge
    Investment
    Economic Benefit
    Reproducibility
    Security Measures
Threat Assessment Of The Trade Secret
Patentability Of The Trade Secret
Estimated Life Expectancy Of The Trade Secret
Additional Files Required To Document The Trade Secret
Validity Status Of The Trade Secret
Source Status Of The Trade Secret
Licensing Status Of The Trade Secret
Legal Reviewer Level Of The Trade Secret
Last Legal Review Date
Last Legal Reviewer Name
Legal Reviewer Comments
Legal Review Schedule
Business Reviewer Level Of The Trade Secret
Last Business Review Date
Last Business Reviewer Name
Business Reviewer Comments
Business Review Schedule
Trade Secret Value
Trade Secret Depreciation Method and Schedule
Net Present Value
Trade Secret Type
Confidentiality Level Of The Trade Secret
```

Data concerning the company, including its structure, its business locations, its employees, its manner of doing business and its preferences for the method of operation of the accounting system, may be entered into the accounting system. A listing of typical company data that may be entered into the accounting system is provided as an example in Table B.

TABLE B
EXAMPLE COMPANY DATA

```
Company Employee Positions And Pay Grades
Company Employee Position Threat Data For Each Position
Company Hierarchy:
      Number Of Levels
      Names Of Levels
      Names Of All Groups At All Levels
Company Locations
Security Measures Available At Company Locations
Security Measures Checklist
Security Threats Checklist
Security Threats To Security Measures Correlation Data
System Configuration Data, Including:
      User Names And Passwords
      Formulae For Calculating Various Factors
      Trade Secret Draft Identifier Alphabetic Or Alphanumeric Sequence
      Trade Secret Application Identifier Alphabetic Or Alphanumeric
      Sequence
      Names And Definitions Of Values For The Six Factors
      System Interface Configuration For Employee Data Retrieval
      Employee Confidentiality Agreement Wording
      Employee Confidentiality Agreement Renewal Periods
      Employee Confidentiality Reminder Wording
      Employee Confidentiality Reminder Renewal Periods
      Department Names For Defining Type Of Trade Secret
      Forms Of Trade Secret For Defining Type Of Trade Secret
      Specific Natures Of Trade Secret For Defining Type Of Trade
      Secret
      Names And Definitions Of Validity Status Of The Trade Secret
      Names And Definitions Of Source Status Of The Trade Secret
      Names And Definitions Of Licensing Status Of The Trade Secret
      Number And Purpose Of One Or More Application Fingerprints
      Submitted Per Trade Secret
      Data Fields Included In Calculation Of Each Application Fingerprint
```

In the preferred embodiment shown, data initially entered into the accounting system to document a potential trade secret may be given a trade secret draft identifier by an indexing processor (IP). This identifier may include a sequential numerical index, and may include an alphabetic or alphanumeric sequence, such as “ABC”, resulting in trade secret draft identifier ABC001 for example. Once the trade secret draft is reviewed, and it has been determined that a trade secret exists, the trade secret is given a trade secret application identifier. This identifier may include a sequential numerical index, and may include an alphabetic or alphanumeric sequence, such as “XYZ”, resulting in application identifier XYZ001 for example.

Data entered into the accounting system may be retained indefinitely. Changes to information may be stored, along with the previous value, the date of change, and the user who made the change, in order to keep an audit trail and historical record.

Part of the data entered may identify whether the trade secret embodies negative know-how. Another part of the data entered may identify whether the trade secret constitutes a combinational trade secret, in which the individual elements may be well-known or understood in the trade, but the combination of these elements is not well-known or understood in the trade and constitutes a trade secret.

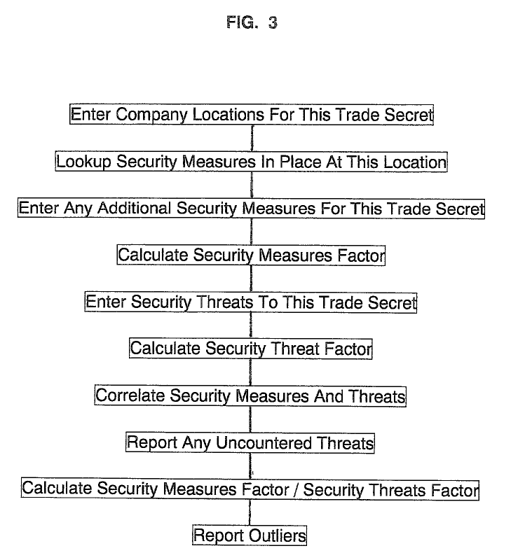

FIG. 3 provides a detailed flow diagram illustrating the treatment of security measures and security threats data by a security processor (SP) of the accounting system for a specific embodiment of the instant invention. The company locations where the trade secret is or was created, stored, used and/or accessible may be entered into the accounting system. The accounting system may use the location data to look up the security measures in place at those company locations, such as locked doors, restrictions on visitor access, 24-hour security guards, and video cameras in key hallways. Information regarding additional security measures taken by the company to secure the trade secret may also be entered for each trade secret, such as disclosure on a need-to-know basis and locking the trade secret documentation in a safe on the premises. Security measures in place at each location and the additional types of security measures that may be taken may be entered as selections from a list. The types of security measures available as selections may be configured by the company to meet its needs. From this information, the accounting system may derive a weighted security measures factor for each trade secret. The calculation may be made using a logical and mathematical formula that may be configured into the accounting system and that the company may deem best meets its needs.

Similarly, the nature of the security threats to the trade secret may be entered into the accounting system for each trade secret. Security threats may be threats due to unauthorized disclosure by employees at trade shows, unintended disclosure to facility visitors, or disclosure by employees in published papers or conference presentations. Security threats may be entered as selections from a list. The types of security threats available as selections may be configured by the company to meet its needs. From this information, the accounting system may derive a weighted security threat factor for each trade secret. The calculation may be made using a logical and mathematical formula that may be configured into the accounting system and that the company may deem best meets its needs.

An additional calculation may be made from the security measure and security threat information to correlate the security measures to the security threats to ensure that the measures are properly designed to counter the assessed threats. For each kind of threat posed to the trade secret, security measures designed to counter that threat may be programmed into the accounting system. The correlation of specific security measures to specific security threats may be configured by the company to meet its needs.

As an example, the security threat of unintended disclosure to visitors may be correlated to security measures such as limiting visitor access to specific areas of the facility, requiring prominent wearing of visitor badges by visitors, and hallway detectors that can detect visitor badges to protect sensitive areas. As a further example, the security threat of disclosure by employees at a trade show may be correlated to security measures of sending reminder email to employees involved in trade show duty prior to the trade show that trade secret confidentiality must be maintained at the trade show, and warning about sensitive conversations in public areas at the trade show.

The accounting system, at the request of a user, may perform an analysis to ensure that each security measure intended to counter each specific security threat entered for each trade secret is in place for each trade secret. The method of performing said analysis may be: for each trade secret on which analysis may be requested, the accounting system may look up the security threats entered for this trade secret; for each security threat listed, the accounting system may look up the correlated security measures; an optional step may be, for each correlated security measure, the accounting system may check the data on this company location to determine whether this security measure is available for this location; for each correlated security measure, the accounting system may determine whether this security measure is in place for this trade secret; the accounting system may generate a report for viewing (user interface device) or printing (printer device) that may list each trade secret measure that is called for but not in place for each trade secret on which analysis may be requested; an optional step may be, for each correlated security measure not in place for each trade secret, to indicate in the report whether this trade secret measure is available at this location.

An additional calculation may be made from the security measure and security threat information to generate the ratio of the security measures factor and the security threats factor for those trade secrets selected for analysis. The accounting system may also identify outlying values of this ratio. These outlying values may represent trade secrets for which the security measures taken may not be justified by a low level of threat, which security measures may result in increased cost to the company, and trade secrets for which the security measures taken may be inadequate for the high level of threat, which inadequacy may result in risk of loss of the trade secret.

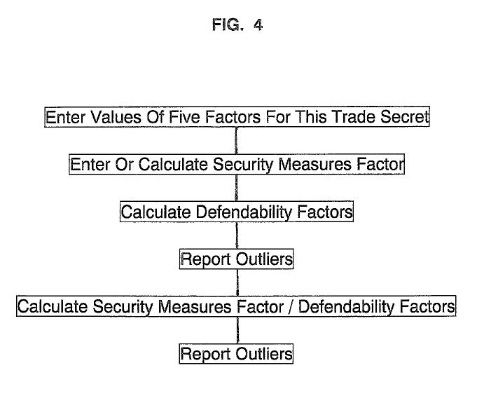

FIG. 4 provides a detailed flow diagram illustrating the treatment of the six factors of a trade secret from Section 757 of the First Restatement of Torts by an information processor (IP) of the accounting system, which treatment may provide verification of the existence of a protectable trade secret under a specifically illustrated embodiment of the invention. The security measures factor may be provided by the above calculations as previously described, or as an alternative embodiment of the instant invention, the security measures factor may be entered directly, bypassing the security measures analysis and calculation of the security measures factor.

The other five factors for each trade secret may be characterized by a value, for example, a number on a scale of 1 to 5, using the descriptive labels and definitions provided as a further example in Table C. Table C also includes descriptive labels and definitions of the security measures factor for the case in which the security measures factor may be entered directly. The accounting system may calculate various weightings of the six factors for each trade secret to provide information to the accounting system's users on the protectability and other features of the trade secret. These weightings we call defendability factors, or defensibility factors, and may be calculated using logical and mathematical formulae that may be configured into the accounting system and that the company may deem best meet its needs.

TABLE C
EXAMPLE DEFINITIONS OF VALUES OF THE SIX FACTORS

1) Inside Knowledge
To whom is the trade secret known within the company?

| | |
|---|---|
| Whole Company | Generally known within the company. |
| Within Division | Generally known within the originating |
| | division. |
| Within Department | Generally known within the originating |
| | department. |
| Within Group | Generally known within the originating group. |
| Select Persons | Known to select persons only. |

2) Outside Knowledge
To whom is the trade secret known within the industry?

| | |
|---|---|
| Three Or More Segments | Known to entities within three or more |
| | segments of the industry. |
| One Or Two Segments | Known to entities within one or two segments |
| | of the industry. |
| Three Or More Entities | Known to three or more entities within the |
| | industry. |
| One Or Two Entities | Known to only one or two entities within the |
| | industry. |
| Not Known | Not known within the industry at all. |

3) Investment
How much has the company invested in developing this trade secret?

| | |
|---|---|
| Little Investment | Created by accident in the course of business |
| | without much specific investment. |
| Some Investment | Created as a minor part of a small project with |
| | a minor investment. |
| Considerable Investment | Created as a major part of a small project with |
| | a minor investment. |
| Substantial Investment | Created as a minor part of a large project with |
| | a major investment. |
| Major Investment | Created as a major part of a large project with |
| | a major investment. |

4) Economic Benefit
What is the importance of the economic benefit provided to the
company or potentially to its competitors by the trade secret?

| | |
|---|---|
| Little Importance | Little or no current economic benefit. |
| Some Importance | Some economic benefit for a portion of the |
| | company's activities. |
| Important | Major economic benefit for a portion of the |
| | company's activities. |
| Very Important | Major economic benefit for many or most of |
| | the company's activities. |
| Extremely Important | Major economic benefit affecting the viability |
| | of the company. |

5) Reproducibility
How hard would it be for an outside firm to independently reproduce
the trade secret?

| | |
|---|---|
| Easy | Minor effort using off-the-shelf tools and |
| | technology or generally available information; |
| | within the capabilities of all competitors. |
| Difficult | Considerable effort, requiring some financial |
| | effort, industry expertise, and some time; |
| | within the capabilities of most competitors. |
| Very Difficult | Substantial effort, requiring considerable |
| | financial effort, specialized expertise, and |
| | considerable time to develop; beyond the |
| | capabilities of most competitors. |
| Extremely Difficult | Major effort, requiring very large financial |
| | investments, rare expertise, and substantial |
| | time to develop; beyond the capabilities of |
| | all but a few competitors. |
| Impossible | Impossible to reproduce at any cost by any |
| | outside firm. |

6) Security
What kind of security precautions has the company taken to protect the
trade secret?

| | |
|---|---|
| Little Security | Little or no security precautions. |
| Some Security | Some precautions, including locked facility and |
| | use of passwords. |
| Much Security | Many security precautions, including locked |
| | and alarmed facility, password protection, |
| | network firewalls. |
| Major Security | Major security precautions, including |
| | need-to-know distribution, entry cards, |
| | off-hours guards, password protection with |
| | password timeouts, and limited or no network |
| | access. |
| Intense Security | Intense security precautions, including severely |
| | limited distribution, secure computers or |
| | equipment, guarded archival facilities or locked |
| | vaults. |

The defendability factors may be compared with one or more threshold values within the accounting system (e.g., within an arithmetic processor (AU) to verify the existence of a trade secret. As used herein, the step of verifying a status of the trade secret as a protectable interest means applying generally accepted legal criteria (e.g., the six factors of a trade secret as set forth in Section 757 of the First Restatement of Torts) to the trade secret, assigning a value under each criterion and generating one or more metrics (“defendability factors”) from the assigned values through the use of logical and mathematical processes, thereby allowing the comparison of results with predetermined threshold values. Comparing the results with predetermined threshold values may be used to provide an objective measure of whether the trade secret is defendable (i.e., defensible). As used herein, a defendable trade secret means information in which the defendability factors in combination with one or more threshold values may be used to establish that a court of competent jurisdiction would more likely than not find the existence of a trade secret.

For example, once values have been assigned under the relevant criteria, the assigned values may be averaged to provide the relevant metric. Alternatively, the six assigned values may be multiplied and the sixth root taken of the product. The metric obtained using such process may be compared by the user or by the accounting system (e.g., within a comparator processor) with a threshold value. Where the metric exceeds the predetermined threshold level, a determination may be made that a protectable trade secret exists.

Various search and reporting options may allow the results of these calculations to be analyzed, viewed, and printed for those trade secrets selected for analysis. Outlying values may be identified by the accounting system, to allow additional inspection of trade secrets for which the defendability factors are very high, which may suggest a very important or defendable trade secret, and additional inspection of trade secrets for which the defendability factors are very low, which may suggest a trade secret that may not be important or defendable or that may not qualify as a trade secret at all.

An additional calculation may be made from the security measures factor and defendability factors information to generate the ratio of the security measures factor and one or more defendability factors for those trade secrets selected for analysis. The accounting system may also identify outlying values of this ratio. These outlying values may represent trade secrets for which the security measures taken may not be justified by a low level of defendability or importance, which security measures may result in increased cost to the company, and trade secrets for which the security measures taken may be inadequate for the high level of defendability or importance, which inadequacy may result in risk of loss of the trade secret.

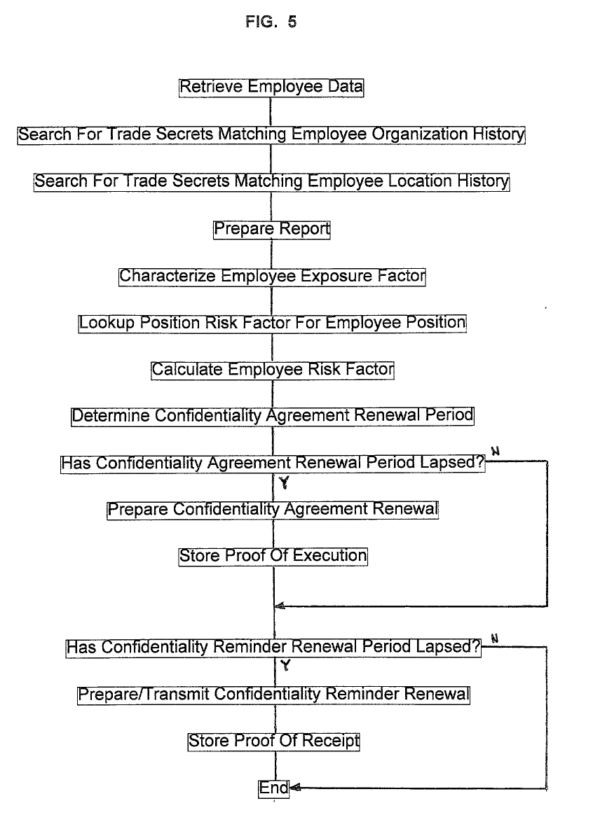

FIG. 5 provides a detailed flow diagram illustrating the analysis of employee data by an employee processor (EP) of the accounting system. In the preferred embodiment shown, employee data may be entered by the method of retrieving data via the system interface from another computer system in which employee data may already be present, such as a payroll computer system. Alternatively, employee data may be entered directly into the accounting system. Such data may contain the employee's name, company locations where employed and associated date ranges, company groups, departments, and divisions in which employed and associated date ranges, employee titles, job functions or fields of employment and associated date ranges, email address in the company email system, and other data.

The accounting system may perform an analysis to identify those trade secrets to which the employee is likely to have been exposed during some time interval of his or her employment. In the preferred embodiment described, the method of performing said analysis may be: for each employee on which analysis may be requested, the accounting system may look up the employee's division, department, and group information for the structural area in the company where the employee was employed, and the corresponding date ranges for each such division, department, and group; for each employee on which analysis may be requested, the accounting system may look up the employee's company location information for the physical area in which the employee was employed, and the corresponding date ranges for each such company location; for each group and corresponding date range in which the employee was employed, the accounting system may search all trade secrets in the accounting system to find all those trade secrets that may have existed during that employment date range and may have been known to that group; for each department and corresponding date range in which the employee was employed, the accounting system may search all trade secrets in the accounting system to find all those trade secrets that may have existed during that employment date range and may have been known to that department; for each division and corresponding date range in which the employee was employed, the accounting system may search all trade secrets in the accounting system to find all those trade secrets that may have existed during that employment date range and may have been known to that division; for each company location and corresponding date range in which the employee was employed, the accounting system may search all trade secrets in the accounting system to find all those trade secrets that may have existed during that employment date range and may have been known to that company location; the accounting system may generate a report, for each employee on which analysis may be requested, for viewing (user interface device) or printing (printer device), that may list each trade secret to which the employee was potentially exposed, and additionally may list in said report whether his or her potential exposure was as part of the group, department, division, or company location.

Alternative embodiments of the said method may include more or fewer structural levels within the company than group, department and division, and similarly, alternative embodiments of this method may apply to more than one location for the trade secret, involving as an example multiple locations where the secret was created, multiple locations where the trade secret was stored, multiple locations where the trade secret was used and multiple locations where the trade secret was accessible. These variations on the method constitute additional embodiments utilizing the instant invention.

Additional alternative embodiments of the said method may generate multiple types of the resulting report described, for example, one type of report for use as attachments to employee confidentiality agreements, one type of report for use during employee exit interviews, one type of report for use as attachments to court filings, one type of report for use as evidence submissions, and one type of report for use as court exhibits. These variations on the method constitute additional embodiments utilizing the instant invention.

A refinement of this method contained in the preferred embodiment shown may be to characterize the employee exposure with one or more employee exposure factors, for example on a 1 to 5 scale. The accounting system may define this value by determining the total number of trade secrets to which the employee has been exposed, the total dollar value of trade secrets to which the employee has been exposed, the total defendability of the trade secrets to which the employee has been exposed, or some other exposure measure, for each employee. The employees may then be divided into groups by the accounting system, comprising in the example shown four quartiles of employee exposure for a 1 to 5 scale.

Another analysis the accounting system may perform on employee data is to characterize the extent to which trade secret data is likely to be compromised by an employee based on the employee's position in the company, with an employee position risk factor. The accounting system may provide the following method for characterizing the extent to which trade secret data is likely to be compromised by the employee based on the employee's position in the company, and determining one or more employee position risk factors: data concerning the turnover rate of employee positions, the technical level of employee positions, the exposure to outsiders associated with employee positions, and other aspects of the employee positions may be entered, such as on a 1 to 5 scale; for each position, the accounting system may calculate various weightings of these aspects of the employee position. These weightings we call employee position risk factors, and may be calculated using logical and mathematical formulae that may be configured into the accounting system and that the company may deem best meet its needs.

An additional analysis the accounting system may perform on employee data is to combine the results of the employee exposure factor and the employee position risk factor, to determine one or more employee risk factors. In the preferred embodiment shown, one or more employee exposure factors and one or more employee position risk factors may be multiplied together to determine one or more employee risk factors. In the general case, the employee risk factor may be calculated using logical and mathematical formulae that may be configured into the accounting system and that the company may deem best meet its needs.

Alternative embodiments of the said method for determining one or more employee risk factors may include utilizing employee-specific information, such as previous history of rapid job changes, supervisor judgment of likelihood of employee departure, proximity to retirement, and other data. These variations on the method constitute additional embodiments utilizing the instant invention.

As also shown in the flow diagram of FIG. 5, the accounting system may manage employee confidentiality agreements and employee confidentiality reminders. The accounting system may maintain an archive of all employee confidentiality agreements, contained as scanned images or by other means. For each employee, the date of each employee confidentiality agreement the employee has executed may be maintained by the accounting system. The period for renewing employee confidentiality agreements may be determined based on one or more employee exposure factors, one or more employee position risk factors, one or more employee risk factors, the company location, transfer or assignment to a new company location, position, or group, department, or division, upcoming attendance at a conference or trade show, or other data or events associated with each employee.

The renewal period for each employee having been determined, the accounting system may compare the renewal period to the time lapsed since the last employee confidentiality agreement was executed for each employee. The accounting system may generate a report listing those employees whose renewal periods have expired, or will expire within a configurable period of the report date, for viewing on the user interface device or printing on the printer device.

The accounting system may additionally print out on the printer device additional employee confidentiality agreements for each employee in said report. The accounting system may retain proof of execution of the confidentiality agreement, such as a scanned image of the agreement bearing the employee's signature.

Alternative embodiments of the said method for managing employee confidentiality agreements may include fixed renewal periods for the whole company, fixed renewal periods for a given employee position or company location, renewal only on departure of the employee, and similar variations. These variations on the method constitute additional embodiments utilizing the instant invention.

The accounting system may manage employee confidentiality reminders, to be sent by email, company mail, United States mail, or other means. The accounting system may maintain an archive of all employee confidentiality reminders sent by the accounting system. For each employee, the date of each employee confidentiality reminder the employee has received may be maintained by the accounting system. The period for renewing employee confidentiality reminders may be determined based on one or more employee exposure factors, one or more employee position risk factors, one or more employee risk factors, the company location, transfer or assignment to a new company location, position, or group, department, or division, upcoming attendance at a conference or trade show, or other data or events associated with each employee.

The renewal period for each employee having been determined, the accounting system may compare the renewal period to the time lapsed since the last employee confidentiality reminder was sent for each employee. The accounting system may generate a report listing those employees whose renewal periods have expired, or will expire within a configurable period of the report date, for viewing on the user interface device or printing on the printer device.

The accounting system may additionally print out on the printer device additional employee confidentiality reminders for each employee in said report, or it may email said confidentiality reminders directly to the employees via the company email system for those employees for whom email service is available. The accounting system may retain a proof of receipt of the employee confidentiality reminder, such as an executed acknowledgement, certified or registered mail receipt, or email acknowledgement, email non-repudiation acknowledgement, or digital signatures, as a scanned document, email record, or in other form.

Alternative embodiments of the said method for managing employee confidentiality reminders may include fixed renewal periods for the whole company, fixed renewal periods for a given employee position or company location, renewal only on departure of the employee, and similar variations. These variations on the method constitute additional embodiments utilizing the instant invention.

The type of trade secret may be documented using a new method that is a feature of the instant invention. In the preferred embodiment, a three-field alphabetic sequence may be used to characterize the trade secret type. For example, the first two fields may comprise a source and form identifier (e.g., similar to the X and Y coordinates of a matrix). The first field may relate to the department within the company that is the user or creator of the trade secret within the company, for example, research, production, and finance. The second field may relate to the form of the trade secret, for example, list, graph, method. The third field may relate to the specific nature of the trade secret from a list within each cell of the matrix. An appended number or letter may denote the specific trade secret within the group described by the three-field alphabetic sequence, resulting in a trade secret description such as ABC1. The company departments, the forms of the trade secret, and the specific nature of the trade secret may all be configured into the accounting system by the company to best meet its needs.

An alternative embodiment of the said method may use additional fields to specify the company locations where the trade secret is created, stored, used, and/or accessible. An additional alternative embodiment of the said method may use numeric or alphanumeric values composed of a plurality of characters to specify one or more of the fields describing the type of trade secret, such as R&D/List/Exp/3. An additional alternative embodiment may use a subset of the fields mentioned, such as the user field and the location-where-used field. These variations on the method illustrate additional embodiments utilizing the instant invention.

Under another illustrated embodiment, it may be desired to be able to refer to trade secrets in a form of code, allowing a precise reference to trade secrets in public places, including courtrooms, or in meetings in which all of the participants are not cleared to hear the content of the trade secret. The use of the code may allow a cross-reference between in-camera proceedings and public proceedings. This alternative embodiment of the said method may describe the type of trade secret through the use of codes that allow only those with the key to the code to understand the said description. The individual fields of the method may be encoded (e.g., using yak/robin/bee/3 instead of the unencoded R&D/List/Exp/3 of the previous example, where yak means R&D, robin means List, and bee means Exp). Alternatively, the coding of the fields may encode multiple fields within a single code (e.g., using buffalo/gamma/3 instead of the unencoded R&D/List/Exp/3 of the previous example, where buffalo means R&D/List, and gamma means Exp). These variations on the method constitute additional illustrated embodiments utilizing the instant invention.

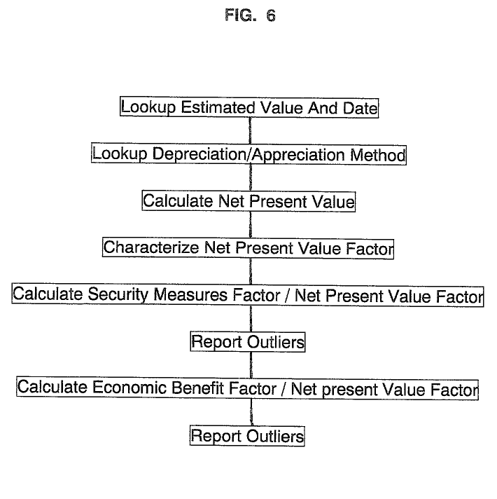

FIG. 6 provides a detailed flow diagram illustrating the analysis of trade secret value data by a value processor (VP) of the accounting system. The accounting system may perform an analysis to determine the net present value and net present value factor, for example on a 1 to 5 scale, of any trade secret in the accounting system. The net present value may be calculated from the estimated commercial value of the trade secret on a specified date, and a depreciation or appreciation method, using Generally Accepted Accounting Principles or other methods. The trade secrets may then be divided into groups by the accounting system, comprising in the example shown four quartiles of net present value for a 1 to 5 scale.

An additional calculation may be made from the security measures factor and the net present value factor to generate the ratio of the security measures factor and the net present value factor for those trade secrets selected for analysis. The accounting system may also identify outlying values of this ratio. These outlying values may represent trade secrets for which the security measures taken may not be justified by a low commercial value of the trade secret, which security measures may result in increased cost to the company, and trade secrets for which the security measures taken may be inadequate for the high commercial value of the trade secret, which inadequacy may result in risk of loss of the trade secret and resulting financial loss.

An additional calculation may be made from the economic benefit factor of a trade secret from Section 757 of the First Restatement of Torts and the net present value factor to generate the ratio of the economic benefit factor and the net present value factor for those trade secrets selected for analysis. The accounting system may also identify outlying values of this ratio. These outlying values may represent trade secrets for which the economic benefit factor and the net present value factor appear to be out of correspondence with each other. A trade secret with a high economic benefit factor should correspond with a high net present value factor and a trade secret with a low economic benefit factor should correspond with a low net present value factor.

In the preferred embodiment shown, data may be entered into the accounting system recording the validity status of the trade secret, the source status of the trade secret, and the licensing status of the trade secret. Typical values for the validity status, the source status, and licensing status of a trade secret are given in Tables D, E, and F.

TABLE D
EXAMPLE VALUES OF THE VALIDITY STATUS OF THE
TRADE SECRET

New. This trade secret application has been recently entered and
has not undergone legal review.
Pending Data. This trade secret application has undergone legal
review and requires the entry of further data to be complete.
Pending Review. This trade secret has undergone legal review and
requires the business review to be complete.
Pending Submission. This trade secret application has undergone
both legal and business review, been determined to be a valid trade
secret application and the data entry is complete. It is ready to be
submitted to the registration system.
Pending Certificate. This trade secret application has undergone both
legal and business review, been determined to be a valid trade secret
application and the data entry is complete. It has been submitted to
the registration system.
Granted. This trade secret has been submitted to the registration
system and been granted a trade secret certificate.
Duplicate. This trade secret has been removed from current status as it
has been determined to be a duplicate of another trade secret in the
system. If the validity status is “Duplicate”, then a “Same As”field
containing an identifier of the duplicate trade secret shall be a required
field.
Declassified. This trade secret has been removed from current status due to
becoming independently widely known in the industry.
Obsolete. This trade secret has been removed from current status due to
being no longer valuable or relevant to the company's business.
Invalid. This trade secret has undergone both legal and business review,
been determined not to be a valid trade secret and the data entry is
complete.

TABLE E
EXAMPLE VALUES OF THE SOURCE STATUS OF THE
TRADE SECRET

In-House. The company developed this trade secret in-house.
Shop Right. The company has a shop right to the use of this trade secret.
Licensed. The company has licensed the use of this trade secret from a
third party.
Purchased. The company has purchased the use of this trade secret from a
third party.

TABLE F
EXAMPLE VALUES OF THE LICENSING STATUS OF THE
TRADE SECRET

Exclusive. The company has retained exclusive rights to this trade secret.
Licensed. The company has licensed the use of this trade secret to a
third party.
Sold. The company has sold the use of this trade secret to a third party.

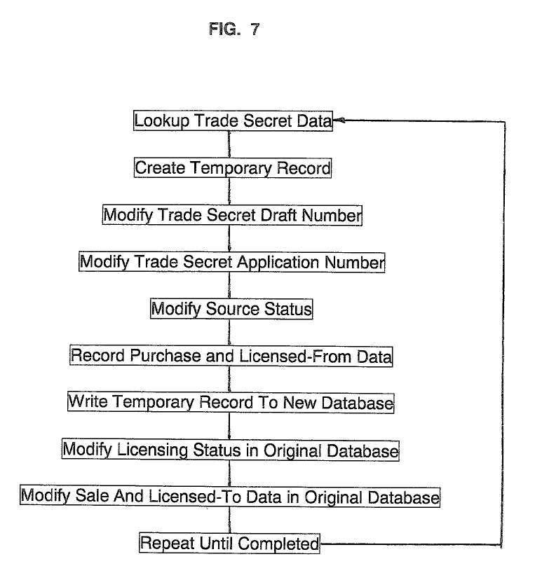

FIG. 7 provides a detailed flow diagram illustrating a method of splitting some of the data in the accounting system database into a new separate database by a database processor (DBP) of the system. This method is intended to allow selling or licensing a group of trade secrets to another entity, such as another company or a division being spun off. Selected trade secrets from the original database may be written to this new database. The alphabetic or alphanumeric sequences of the draft identifiers and application identifiers may be automatically changed at this time. The source status of the trade secrets in the new database may be changed automatically at this time. The licensing status of the trade secrets in the original database may be changed automatically at this time. Purchase and licensed-from data, such as seller, price, and terms and conditions, may be recorded by the accounting system in the new database. Sale and licensed-to data, such as purchaser, price, and terms and conditions, may be recorded by the accounting system in the original database.

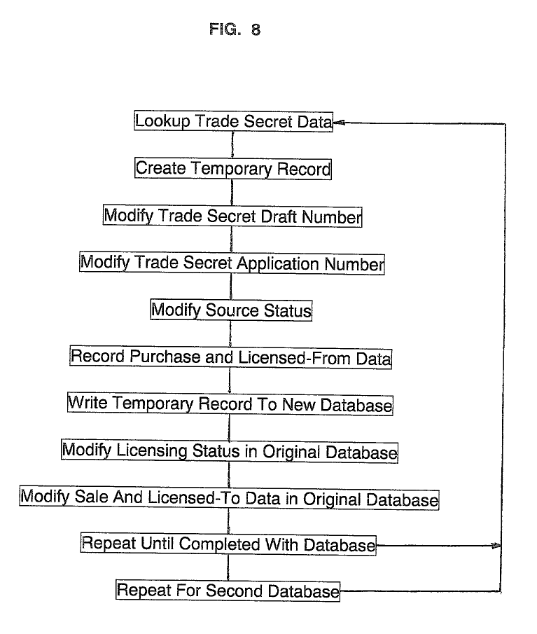

FIG. 8 provides a detailed flow diagram illustrating a method of merging the data in two accounting system databases into a new separate database. This method is intended to allow the pooling of trade secrets for a company merger, acquisition, or joint venture. All trade secrets from the two original databases may be written to this new database. The alphabetic or alphanumeric sequences of the draft identifier and application identifier of both original databases may be automatically changed at this time. The source status of the trade secrets in the new database may be changed automatically at this time. The licensing status of the trade secrets in the two original databases may be changed automatically at this time. Purchase and licensed-from data, such as seller, price, and terms and conditions, may be recorded by the accounting system in the new database. Sale and licensed-to data, such as purchaser, price, and terms and conditions, may be recorded by the accounting system in the two original databases.

To this point, this description has concerned itself solely with the computer system used for the documentation, analysis, auditing, accounting, and protection of trade secrets, called the accounting system. We now describe the unique device and methods to provide registration and verification of the existence, ownership, contents, and other information relating to trade secrets.

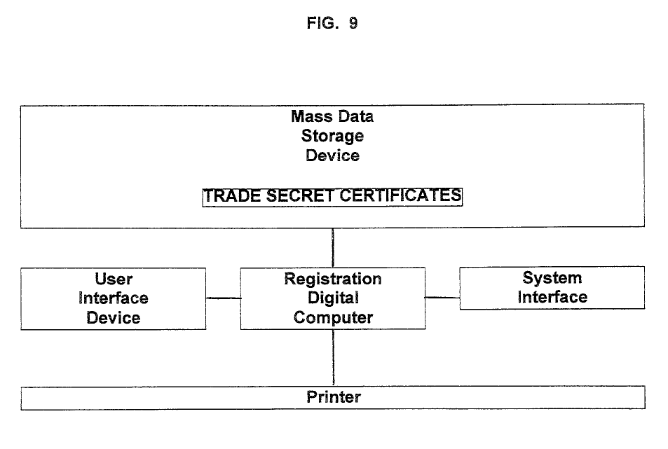

FIG. 9 is a generalized block diagram illustrating the structure of a specific computer system for implementing the invention for registration and verification of the existence, ownership, contents, and other information relating to trade secrets. In the context of this invention, this computer system is called the trade secret registration system, or the registration system.

FIG. 9 illustrates a means for data processing, called a digital computer, connected to one or more means for entering the data and displaying the data and the results of searches and calculations, called a user interface device. The user interface device may be, but is not limited to, any number and combination of the following, their equivalents, replacements, or improvements:

A directly connected monitor and keyboard.

A directly connected computer terminal.

A directly connected personal computer.

A computer terminal connected via a modem over telephone lines.

A personal computer connected via a modem over telephone lines.

A terminal connected via one or more local or wide area networks, including the Internet, intranet, private virtual network, satellite link, or other means.

A personal computer connected via one or more local or wide area networks, including the Internet, intranet, private virtual network, satellite link, or other means.

A terminal connected to another computer system, which is then connected to the described system via direct connection, a modem over telephone lines, or one or more local or wide area networks, including the Internet, intranet, private virtual network, satellite link, or other means.

A personal computer connected to another computer system, which is then connected to the described system via direct connection, a modem over telephone lines, or one or more local or wide area networks, including the Internet, intranet, private virtual network, satellite link, or other means.

A document scanner, connected via any of the above means.

Speech recognition device, connected via any of the above means.

Holographic or other projection device, connected via any of the above means.

Inductive neural pickup device, connected via any of the above means.

Direct optical nerve induction device, connected via any of the above means.

At least one means for storing the data entered into the system, as well as the programs required to implement the system, and the results of searches and calculations of the system that may be stored for later use or display, called a mass data storage device, is provided. This mass data storage device may be, but is not limited to, any combination of the following, their equivalents, replacements, or improvements:

Magnetic memory hard disk drive.

Magnetic memory flexible (floppy) disk drive.

CD-ROM (Compact Disc-Read Only Memory) drive.

FLASH-programmable ROM device or devices.

A molecular storage device consisting of data storage by the means of manipulating the structures of molecules within the device.

A means for printing out data, displays, and the results of searches and calculations, called a printer, may be provided. The printer may be, but is not limited to, any combination of the following, their equivalents, replacements, or improvements:

A directly connected printer.

A printer connected via a modem over telephone lines.

A printer connected via one or more local or wide area networks, including the Internet, intranet, private virtual network, satellite link, or other means.

A printer connected to the user input device.

An e-book, an electronic device for the display of downloaded text and data.

A bionic memory implant device, downloaded via any of the above means.

One or more means for connecting the system into other computer systems, called system interfaces, may be provided. A system interface may allow the system to input and output data (user interface functions), to print to one or more devices (printer functions), and to store and retrieve data (mass data storage functions) to and from another computer system that may provide some or all of the user interface functions, printer functions, or mass data storage functions of the system. A system interface may be implemented via direct connection, a modem over telephone lines, the use of removable storage media, or one or more local or wide area networks, including the Internet, intranet, private virtual network, satellite link, or other means. In particular, a system interface is the preferred method for connecting the registration system to one or more accounting systems, whose operation has been previously described.

In this document, ‘processor’ means a device capable of performing the steps of the specific process under discussion, such as indexing, registration, or communication. This is to be distinguished from the casual use of the term ‘processor’ in the computer field to refer to a single and distinct Central Processing Unit (“CPU”). In particular, various embodiments of the instant invention may use one CPU within the accounting system to perform the steps of each of the processors contained therein (e.g., within a multiprocessing environment), or one CPU within the accounting system to perform the steps of a plurality of the processors contained therein, or multiple CPUs to perform the steps of a single processor contained therein, or a combination of these.

It should be evident to those skilled in the art that the digital computer and its user interface, storage, and printing devices, and its system interfaces are an underlying technology for the implementation of the system, and the implementation of each of these aspects of the underlying technology are independent of the invention described.

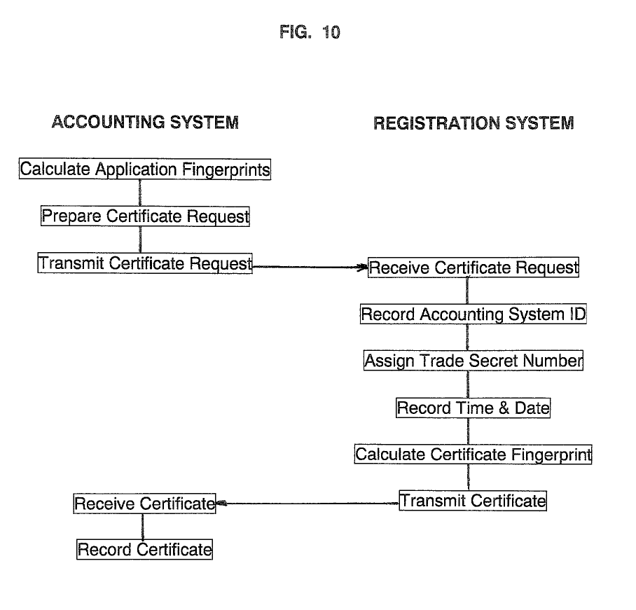

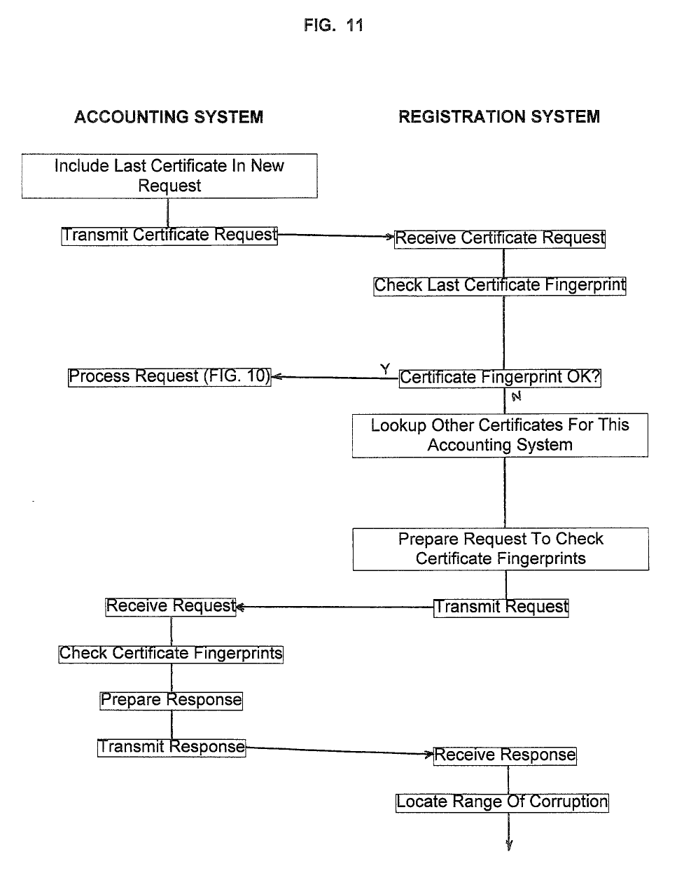

FIG. 10 provides a detailed flow diagram illustrating a methodology and structural flow for a specific embodiment of the instant invention. As illustrated, when a trade secret certificate request is made, an application processor (AP) within the accounting system may calculate one or more identification codes, which we call application fingerprints, from the trade secret data contained in the trade secret application. These identification codes may be calculated using a deterministic one-way algorithm, such as secure one-way hash codes, thereby providing a unique digital fingerprint associated with the information. No trade secret information used in calculating these codes can be changed without changing the resulting code.

A communication processor (CP) of the accounting system may transmit the trade secret certificate request containing the following information to the registration system:

The unique identifier of the accounting system.

The trade secret application identifier.

One or more trade secret application fingerprints.

The registration system may store the received data together with a trade secret certificate identifier and the date and time the request was received. A registration processor (RP) within the registration system may calculate a new identification code, which we call the certificate fingerprint, for transmission back to the accounting system. This identification code may be calculated using a deterministic one-way algorithm, such as secure one-way hash codes, thereby providing a unique digital fingerprint associated with the information. No registration information used in calculating these codes can be changed without changing the resulting code.

The registration system may transmit the trade secret certificate containing the following information to the accounting system:

The trade secret application identifier.

The trade secret certificate identifier.

The trade secret application fingerprints.

The trade secret certificate fingerprint.

In the general case, the accounting system may calculate more than one application fingerprint for each trade secret certificate request.

The application fingerprints may be calculated from different subsets of the trade secret data in the trade secret application. In the preferred embodiment, one application fingerprint may be calculated for each of the following subsets of data within the trade secret application:

Security data, including data documenting the security threats and security measures.

Financial data, including data documenting the value of the trade secret.

Legal data, including data documenting the six factors values for the trade secret and review information.

Licensing data, including data documenting the source and licensing status of the trade secret.

Trade secret documentation, including the name of the trade secret, where it is or was created, stored, used and/or accessible, and additional files such as diagrams, charts, scanner images, and other files that may be provided by the user to document the content of the trade secret.

Multiple application fingerprints permit the release of partial information about the trade secret or trade secrets in the system, for example for banking, insurance, legal, or other purposes, without releasing more information than necessary. In particular, it may be desired to be able to release verifiable information to banks, insurers, and other third parties without releasing the trade secret itself. The application fingerprints allow third parties to verify the subset of information they have been provided, by recalculating one or more application fingerprints and comparing same with the appropriate application fingerprints in the registration system.

It is a further feature of the instant invention that additional multiple application fingerprints may be calculated and registered for the same trade secret at later dates, and which may incorporate new or modified information, including modifications, improvements, and enhancements to the trade secret. The instant invention may provide a method for retrieving all registration information associated with a trade secret using a single trade secret certificate identifier that corresponds to all of these registrations and application fingerprints.

Alternative embodiments of the said method for trade secret certificate requests and trade secret certificates may include using only one application fingerprint, providing more or fewer subsets of trade secret application data on which application fingerprints may be calculated, providing for user configuration of the subsets of trade secret data, including naming of the subsets and specifying which data fields may be contained in which subsets, and specifying hierarchical systems of subsets of the trade secret application data. These variations on the method constitute additional embodiments utilizing the instant invention.

An additional alternative embodiment of the said method for trade secret certificate requests and trade secret certificates may include regarding the company data (e.g., locations, groups, departments, and divisions, and security measures associated with locations), the employee data (e.g., employee names, employee confidentiality agreements and proofs-of-receipt, and employee risk factors) and the configuration data (e.g., company preferences for various system parameters and operation options) as trade secrets in themselves, and registering them in the same manner. This data may be similarly grouped in subsets and may be registered using multiple application fingerprints as previously described. Alternatively, these data subsets may be registered in a similar manner, but with a certificate identifier designed to differentiate company, employee and system data from trade secret data. These variations on the method constitute additional embodiments utilizing the instant invention.

An additional alternative embodiment of the said method for trade secret certificate requests and trade secret certificates may include regarding the database backups, historical data, and audit trail data in the accounting system as trade secrets in themselves, and registering them in the same manner. This data may be similarly grouped in subsets and may be registered using multiple application fingerprints as previously described. Alternatively, these data subsets may be registered in a similar manner, but with a certificate identifier designed to differentiate backup, historical, and audit trail data from trade secret data. These variations on the method constitute additional embodiments utilizing the instant invention.

The registration system may be used to allow interested parties, for example in the business, financial, banking, accounting, insurance, securities and legal professions, to verify the trade secret portfolio of organizations using the system. For example, an indexing processor (IP) of the registration system may create and maintain a directory containing some or all of the instances of some or all of the following items of registration information: the certificate identifiers granted; the time and date of the granting of each certificate identifier; the unique identifier of the accounting system requesting each certificate identifier; the trade secret certificate fingerprints of each registration transaction; the original submitted trade secret application identifiers of each registration transaction; the original submitted trade secret application fingerprints of each registration transaction; and other data concerning the circumstances and content of each registration transaction. The content of this directory may be made available, whether on-line, via transportable media such as CD-ROM or by other means, including written communication, allowing verification of certificate numbers and other data in the directory. The content of this directory may be made available to any interested party, only to parties authorized by the accounting system associated with the particular content of the directory to be verified, on a subscription basis to parties having a frequent need for such verification, or under other limitations or restrictions.

One method of generating certificate fingerprints involves performing the calculation of the current certificate fingerprint using the current certificate request data and the previous certificate fingerprint, creating a chained list of certificates, as described in U.S. Pat. No. 5,136,646. If this or similar alternative method of calculation is used, one embodiment of the instant invention provides for all of the above registration features with the following methods.

In this embodiment, the trade secret registration system may provide an additional field, which we call the trade secret certificate identifier, within the record shown in Column 7 Lines 15-20 of U.S. Pat. No. 5,136,646, which we call a trade secret record. The trade secret certificate identifier may be a unique sequential number provided by the registration system. When a trade secret application is received, the trade secret registration system may look up the next trade secret certificate identifier in sequence and the next transaction number in sequence. For a trade secret certificate request containing as an example six application fingerprints, six transaction records of the form described in the referenced patent may be created, each containing the identical trade secret certificate identifier. The trade secret certificate returned to the application system making the request may contain the trade secret certificate identifier granted, the trade secret certificate fingerprints of the transaction, the original submitted trade secret application identifier and the original submitted trade secret application fingerprints.

Subsequent additional information, modifications, improvements, and enhancements of the same trade secret may be registered through the submission by the accounting system to the registration system of a revised trade secret certificate request. The accounting system may transmit the revised trade secret certificate request containing the following information to the registration system:

The unique identifier of the accounting system (“Client ID” in the referenced patent).

The trade secret certificate identifier.

One or more trade secret application fingerprints.

The registration system may verify that the client ID matches the client ID of the original trade secret record for this trade secret certificate identifier. The registration system may process the trade secret application fingerprints in the manner previously described, and may create one trade secret record for each application fingerprint submitted. Each new trade secret record may contain the trade secret certificate identifier. The trade secret certificate returned to the application system making the request may contain the trade secret certificate identifier granted, the trade secret certificate fingerprints of the transaction, the original submitted trade secret application identifier and the original submitted trade secret application fingerprints.

Registration of other data, such as company data, employee data, configuration data, database backups, historical data, and audit trail data, may be registered through the submission by the accounting system to the registration system of a registration certificate request. The accounting system transmits the registration certificate request containing the following information to the registration system:

The unique identifier of the accounting system (“Client ID” in the referenced patent).

An information registration request identifier.

One or more information registration application fingerprints.

The registration system may process the information registration application fingerprints in the manner previously described, and may create one trade secret record for each application fingerprint submitted. The trade secret records created may contain no trade secret certificate identifier. The information registration certificate returned to the application system making the request may contain the information registration certificate identifier granted, the information registration certificate fingerprints of the transaction, the original submitted information registration request identifier and the original submitted information registration application fingerprints.

Again, one method of generating certificate fingerprints involves performing the calculation of the current certificate fingerprint using the current certificate request data and the previous certificate fingerprint, creating a chained list of certificates, as described in U.S. Pat. No. 5,136,646. If this or similar alternative method of calculation is used, the registration system and the accounting system may perform continuous database checks and locate database corruptions during the registration of new trade secrets using a further feature of the instant invention.

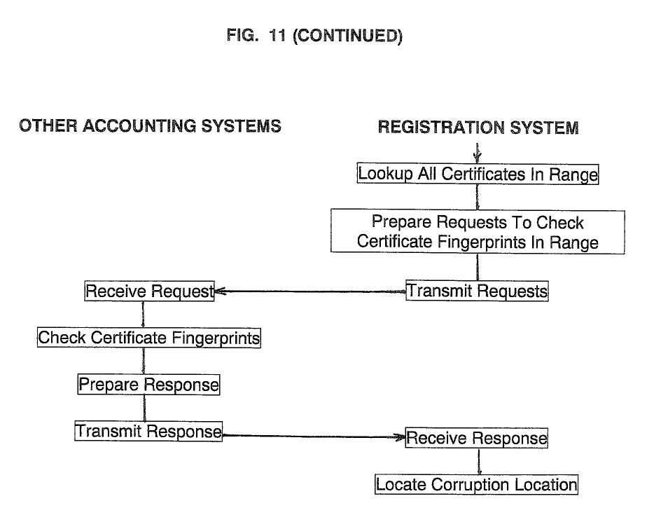

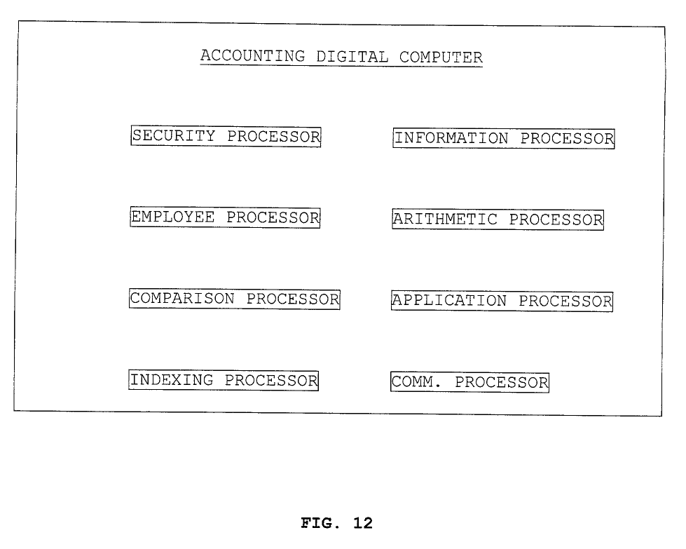

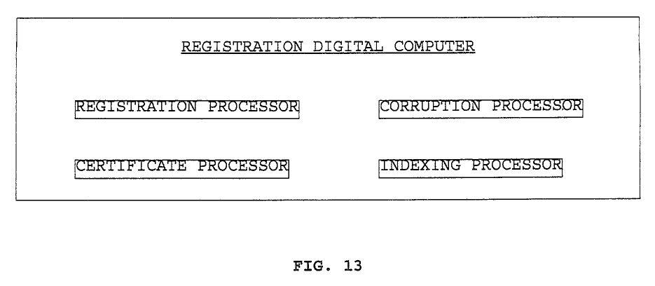

FIG. 11 provides a detailed flow diagram illustrating a method of checking the database integrity and locating database corruptions during normal operation. In the preferred embodiment illustrated, the method for performing the database check may be as follows. The registration system may continuously recalculate the certificate fingerprints for every transaction in the database, and may perform this task as a background task, i.e., when other tasks are not running. This ensures that the chained list of certificate fingerprints in the registration database remains correctly chained. If any certificate fingerprint fails to check, a corruption may have been found.

When sending a trade secret certificate request, the accounting system may also include a copy of the last trade secret certificate it has received. The registration system may check the trade secret certificate fingerprint sent by the accounting system against the registration database. If the chained list of the registration database is correctly chained, and the trade secret certificate fingerprint matches, the database integrity is ensured up to the point of the matching trade secret certificate fingerprint. The registration system need perform no additional tasks, and the new trade secret certificate may be processed normally.

If the trade secret certificate fingerprint sent by the accounting system does not match that contained in the registration database, the registration database may be corrupted prior to the non-matching certificate fingerprint. The registration system may send the requesting accounting system all trade secret certificates in the registration database previously registered by that accounting system. The accounting system may compare all the trade secret certificates in its local database to those received from the registration system, to find the most recent non-corrupted record. The accounting system may send back the most recent non-corrupted certificate to the registration system. The registration system has now bounded the corruption between the most recent non-corrupted certificate for that accounting system and the next certificate for that accounting system.

The registration system may now send the certificates within the bounded range of the corruption to the accounting systems that own these certificates, requesting verification against the local databases of the accounting systems. Each accounting system receiving such a request may verify the certificate or certificates received, and may return the status—corrupted or non-corrupted—of each certificate to the registration system. The registration system can thereby determine the location of the corruption.

Once the corruption has been found, the database may be restored from backup, or through the use of the data in the local databases of the accounting systems. The preferred method of providing backup to the registration system may be through the use of a write-only mass data storage device such as a CD-ROM, in which each registration transaction may be recorded as it occurs. In this manner, the backup data may be recorded as the database is built. For best security of the backup, an off-site device may provide the greatest protection against tampering.

An alternative embodiment of the said method for locating database corruptions during normal operation may include the registration system, once a corruption is detected, sending the requesting accounting system only a portion of the trade secret certificates in the registration database previously registered by that accounting system. This extension of the method may be used repetitively to reduce the range within which the corruption may exist. This extension of the said method may be especially appropriate when the number of certificates previously registered is large. This variation on the method constitutes an additional embodiment utilizing the instant invention.

It should be evident to persons skilled in the art that the methods disclosed have wider application than to the specific system for registration and verification of the existence, ownership, contents, and other information relating to trade secrets. These methods are not anticipated or disclosed in the prior art. These unique methods are claimed in addition to the system for registration and verification of the existence, ownership, contents, and other information relating to trade secrets.

A specific embodiment of a method and apparatus for protecting trade secrets according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A trade secret accounting system, for providing documentation, analysis, auditing, accounting, protection, and other management of trade secrets of an organization, said system comprising:
a) data processing means for performing indexing of trade secrets, accessing and storing data about or relating to trade secrets, and performing calculations about or relating to trade secrets;
b) user interface means for entering data and displaying data and the results of searches and calculations; and
c) mass data storage means for storing data entered into the system, as well as the programs required to implement the system, and the results of searches and calculations performed by the system.

2. The system of claim 1, further comprising printer means for printing out data, displays, and the results of searches and calculations.

3. The system of claim 1, further comprising system interface means for providing user interface functions, printing functions, or mass data storage functions through the use of another computer system, or for connection to the registration system.

4. The system of claim 1, further comprising means for indexing trade secret drafts.

5. The system of claim 1, further comprising means for indexing trade secret applications.

6. The system of claim 1, further comprising:
a) means for indexing trade secret drafts;
b) means for indexing trade secret applications; and
c) means for converting trade secret drafts into trade secret applications.

7. The system of claim 1, further comprising means for storing changes to the data to provide audit trail and history of all changes.

8. The system of claim 1, further comprising means for characterizing whether the trade secret constitutes negative know-how.

9. The system of claim 1, further comprising means for characterizing whether the trade secret is a combinational trade secret.

10. The system of claim 1, further comprising means for specifying security measures by company location.

11. The system of claim 10, further comprising means for associating said specified security measures with a trade secret based on one or more company locations associated with a trade secret.

12. The system of claim 1, further comprising means for specifying security measures used to protect a trade secret.

13. The system of claim 12, further comprising means for calculating from said specified security measures a security measures factor for a trade secret.

14. The system of claim 1, further comprising means for specifying security threats to a trade secret.

15. The system of claim 14, further comprising means for calculating from said specified security threats a security threats factor for a trade secret.

16. The system of claim 1, further comprising:
a) means for specifying security measures used to protect a trade secret;
b) means for specifying security threats to a trade secret; and
c) means for entering and recording which security measures counteract each security threat.

17. The system of claim 16, further comprising means for determining which security measures are needed for each trade secret based on the security threats to each trade secret.

18. The system of claim 1, further comprising:
a) means for specifying security measures by company location;
b) means for specifying security threats to a trade secret;
c) means for entering and recording which security measures counteract each security threat;
d) means for determining which security measures are needed for each trade secret based on the security threats to each trade secret; and
e) means for determining which security measures needed for each trade secret based on the security threats to each trade secret are also available at the company location.

19. The system of claim 1, further comprising:
a) means for specifying security measures used to protect a trade secret;
b) means for calculating from said specified security measures a security measures factor for a trade secret;
c) means for specifying security threats to a trade secret;
d) means for calculating from said specified security threats a security threats factor for a trade secret.; and
e) means for calculating from the security measures factor and security threats factor a ratio associated with a trade secret.

20. The system of claim 19, further comprising means for analyzing said ratio to identify outlying values for further inspection.

21. The system of claim 1, further comprising means for specifying values for the six factors of a trade secret enumerated in Section 757 of the First Restatement of Torts.

22. The system of claim 21, further comprising means for calculating various weighted values of the six factors using logical and mathematical equations to generate a single defendability factor associated with a trade secret.

23. The system of claim 22, further comprising means for analyzing said defendability factor to identify outlying values for further inspection.

24. The system of claim 1, further comprising:
a) means for specifying security measures used to protect a trade secret;
b) means for calculating from said specified security measures a security measures factor for a trade secret;
c) means for specifying values for the six factors of a trade secret enumerated in Section 757 of the First Restatement of Torts;
d) means for calculating various weighted values of the six factors using logical and mathematical equations to generate a single defendability factor associated with a trade secret; and
e) means for calculating from the security measures factor and the single defendability factor a ratio associated with a trade secret.

25. The system of claim 24, further comprising means for analyzing said ratio to identify outlying values for further inspection.

26. The system of claim 1, further comprising means for determining employee exposure to a trade secret based on the organization and the date range within which he or she was employed and the organization and the date range within which the trade secret was known within that organization.

27. The system of claim 1, further comprising means for determining employee exposure to a trade secret based on the company location and the date range within which he or she was employed and the company location and the date range within which the trade secret was known within that company location.

28. The system of claim 1, further comprising:
a) means for determining employee exposure to a trade secret based on the organization and the date range within which he or she was employed and the organization and the date range within which the trade secret was known within that organization;
b) means for determining employee exposure to a trade secret based on the company location and the date range within which he or she was employed and the company location and the date range within which the trade secret was known within that company location; and
c) means for generating a report documenting the employee exposure to a trade secret based on the organization and the company location and the date range within which the trade secret was known within that organization or company location.

29. The system of claim 28, further comprising means for characterizing employee exposure to company trade secrets in one or more employee exposure factors.

30. The system of claim 1, further comprising means for characterizing security risk associated with an employee's position in the company in one or more employee position risk factors.

31. The system of claim 1, further comprising:
a) means for determining employee exposure to a trade secret based on the organization and the date range within which he or she was employed by the organization and the date range within which the trade secret was known within that organization;
b) means for determining employee exposure to a trade secret based on the company location and the date range within which he or she was employed and the company location and the date range within which the trade secret was known within that company location;
c) means for generating a report documenting the employee exposure to a trade secret based on the organization and the company location and the date range within which the trade secret was known within that organization or company location;
d) means for characterizing employee exposure to company trade secrets in one or more employee exposure factors;
e) means for characterizing security risk associated with an employee's position in the company in one or more employee position risk factors; and
f) means for calculating from one or more employee exposure factors and one or more employee position risk factors an employee risk factor.

32. The system of claim 1, further comprising means for archiving employee confidentiality agreements and the dates on which the employee confidentiality agreements were executed.

33. The system of claim 1, further comprising means for determining a renewal period for employee confidentiality agreements from elements of employee data, employee factors, and employee reports.

34. The system of claim 1, further comprising:
a) means for archiving employee confidentiality agreements and the dates on which the employee confidentiality agreements were executed;
b) means for determining a renewal period for employee confidentiality agreements from elements of employee data, employee factors, and employee reports; and
c) means for calculating employee confidentiality agreements due for renewal.

35. The system of claim 34, further comprising means for generating for viewing or printing a report listing employee confidentiality agreements due for renewal.

36. The system of claim 34, further comprising means for printing employee confidentiality agreements due for renewal.

37. The system of claim 1, further comprising means for archiving employee confidentiality reminders and the dates on which the employee confidentiality reminders were sent.

38. The system of claim 1, further comprising means for determining a renewal period for employee confidentiality reminders from elements of employee data, employee factors, and employee reports.

39. The system of claim 1, further comprising:
a) means for archiving employee confidentiality reminders and the dates on which the employee confidentiality reminders were sent;
b) means for determining a renewal period for employee confidentiality reminders from elements of employee data, employee factors, and employee reports; and
c) means for calculating employee confidentiality reminders due for renewal.

40. The system of claim 39, further comprising means for generating for viewing or printing a report listing employee confidentiality reminders due for renewal.

41. The system of claim 39, further comprising means for printing employee confidentiality reminders due for renewal.

42. The system of claim 41, further comprising means for retaining proof-of-receipt documents for hard-copy employee confidentiality reminders.

43. The system of claim 39, further comprising means for emailing employee confidentiality reminders due for renewal directly to the employee.

44. The system of claim 43, further comprising means for retaining proof-of-receipt documents for email employee confidentiality reminders.

45. The system of claim 1, further comprising means for creating a specification of the type of a trade secret using alphabetic, numeric, or alphanumeric fields to characterize information about the type of trade secret.

46. The system of claim 45, further comprising means for encoding said specification of the type of a trade secret.

47. The system of claim 1, further comprising means for calculating the net present value of a trade secret from an estimated commercial value on a given date and a depreciation or appreciation method.

48. The system of claim 47, further comprising means for characterizing the net present value of a trade secret in a net present value factor.

49. The system of claim 1, further comprising:
a) means for specifying security measures used to protect a trade secret;
b) means for calculating from said specified security measures a security measures factor for a trade secret;
c) means for calculating the net present value of a trade secret from an estimated commercial value on a given date and a depreciation or appreciation method;
d) means for characterizing the net present value of a trade secret in a net present value factor; and
e) means for calculating from the security measures factor and the net present value factor a ratio associated with a trade secret.

50. The system of claim 49, further comprising means for analyzing said ratio to identify outlying values for further inspection.

51. The system of claim 1, further comprising:
a) means for specifying values for the six factors of a trade secret enumerated in Section 757 of the First Restatement of Torts;
b) means for calculating the net present value of a trade secret from an estimated commercial value on a given date and a depreciation or appreciation method;
c) means for characterizing the net present value of a trade secret in a net present value factor; and
d) means for calculating from the economic benefit factor and the net present value factor a ratio associated with a trade secret.

52. The system of claim 51, further comprising means for analyzing said ratio to identify outlying values for further inspection.

53. The system of claim 1, further comprising means for specifying source status of a trade secret.

54. The system of claim 1, further comprising means for recording purchase and licensed-from data of a trade secret.

55. The system of claim 1, further comprising means for specifying licensing status of a trade secret.

56. The system of claim 1, further comprising means for recording sale and licensed-to data of a trade secret.

57. The system of claim 1, further comprising means for splitting data associated with selected trade secrets from one database into a separate database.

58. The system of claim 1, further comprising:
a) means for indexing trade secret drafts;
b) means for splitting data associated with selected trade secrets from one database into a separate database; and
c) means for modifying the alphabetic or alphanumeric sequence of the trade secret draft identifier of selected trade secrets when splitting data associated with said trade secrets into a separate database.

59. The system of claim 1, further comprising:
a) means for indexing trade secret applications;
b) means for splitting data associated with selected trade secrets from one database into a separate database; and
c) means for modifying the alphabetic or alphanumeric sequence of the trade secret application identifier of selected trade secrets when splitting data associated with said trade secrets into a separate database.

60. The system of claim 1, further comprising:
a) means for specifying source status of a trade secret;
b) means for splitting data associated with selected trade secrets from one database into a separate database; and
c) means for modifying the source status of selected trade secrets when splitting data associated with said trade secrets into a separate database.

61. The system of claim 1, further comprising:
a) means for recording purchase and licensed-from data of a trade secret;
b) means for splitting data associated with selected trade secrets from one database into a separate database; and
c) means for modifying the purchase and licensed-from data of selected trade secrets when splitting data associated with said trade secrets into a separate database.

62. The system of claim 1, further comprising:
a) means for specifying licensing status of a trade secret;
b) means for splitting data associated with selected trade secrets from one database into a separate database; and
c) means for modifying the licensing status of selected trade secrets when splitting data associated with said trade secrets into a separate database.

63. The system of claim 1, further comprising:
a) means for recording sale and licensed-to data of a trade secret;
b) means for splitting data associated with selected trade secrets from one database into a separate database; and
c) means for modifying the sale and licensed-to data of selected trade secrets when splitting data associated with said trade secrets into a separate database.

64. The system of claim 1, further comprising means for merging data associated with selected trade secrets from two databases into a single database.

65. The system of claim 1, further comprising:
a) means for indexing trade secret drafts;
b) means for merging data associated with selected trade secrets from two databases into a single database; and
c) means for modifying the alphabetic or alphanumeric sequence of the trade secret draft identifier of selected trade secrets when merging data associated with said trade secrets into a single database.

66. The system of claim 1, further comprising:
a) means for indexing trade secret applications;
b) means for merging data associated with selected trade secrets from two databases into a single database; and
c) means for modifying the alphabetic or alphanumeric sequence of the trade secret application identifier of selected trade secrets when merging data associated with said trade secrets into a single database.

67. The system of claim 1, further comprising:
a) means for specifying source status of a trade secret;
b) means for merging data associated with selected trade secrets from two databases into a single database; and
c) means for modifying the source status of selected trade secrets when merging data associated with said trade secrets into a single database.

68. The system of claim 1, further comprising:
a) means for recording purchase and licensed-from data of a trade secret;
b) means for merging data associated with selected trade secrets from two databases into a single database; and
c) means for modifying the purchase and licensed-from data of selected trade secrets when merging data associated with said trade secrets into a single database.

69. The system of claim 1, further comprising:
a) means for specifying licensing status of a trade secret;
b) means for merging data associated with selected trade secrets from two databases into a single database; and
c) means for modifying the licensing status of selected trade secrets when merging data associated with said trade secrets into a single database.

70. The system of claim 1, further comprising:
a) means for recording sale and licensed-to data of a trade secret;
b) means for merging data associated with selected trade secrets from two databases into a single database; and
c) means for modifying the sale and licensed-to data of selected trade secrets when merging data associated with said trade secrets into a single database.

71. A trade secret registration system, for providing registration and verification of the existence, ownership, contents, and other information relating to trade secrets, said system comprising:
a) data processing means for performing indexing of trade secrets, accessing and storing data about or relating to trade secrets, and performing calculations about or relating to trade secrets;
b) user interface means for entering data and displaying data and the results of searches and calculations; and
c) mass data storage means for storing data entered into the system, as well as the programs required to implement the system, and the results of searches and calculations performed by the system.

72. The system of claim 71, further comprising printer means for printing out data, displays, and the results of searches and calculations.

73. The system of claim 71, further comprising system interface means for providing user interface functions, printing functions, or mass data storage functions through the use of another computer system, or for connection to the accounting system.

74. The system of claim 1, further comprising means for associating more than one application fingerprint with a single trade secret.

75. The system of claim 71, further comprising means for registering more than one application fingerprint with a single trade secret.

76. The system of claim 71, further comprising means for registering an additional application fingerprint with a trade secret previously registered.

77. The system of claim 71, further comprising means for registering an application fingerprint associated with other data in the same registration record database with trade secret registrations.

78. The system of claim 71, further comprising means for maintaining a directory of registration information.

79. The system of claim 78, further comprising means for publishing a directory of registration information.

80. The system of claim 79, further comprising means for publishing a directory of registration information on a limited basis.

81. The systems of claims 1 and 71, further comprising means for communicating data between the systems, forming in effect a single system.

82. The system of claim 81, further comprising means for detecting corruption in the trade secret registration database.

83. The system of claim 81, further comprising means for detecting corruption in the trade secret registration database during normal operation.

84. The system of claim 81, further comprising means for locating corruption in the trade secret registration database.

85. The system of claim 71, further comprising means for making contemporaneous backups of transactions performed by the trade secret registration system.

86. The system of claim 71, further comprising means for providing multiple registration records with an additional index number to create a registration that may have multiple entries.

87. The system of claim 86, further comprising means for creating a registration record without said additional index number to accommodate registrations with single entries in the same registration record database as those with multiple entries.

88. The system of claim 71, further comprising means for creating an additional registration record with an index number already in use to create a registration with multiple entries that span a time period.

89. The system of claim 71, further comprising means for creating a registration record without said index number to accommodate registrations of a non-indexed type in the same registration record database as those of the indexed type.

90. The system of claim 71, further comprising means for occasionally recalculating certificate fingerprints in order to provide an indication of database corruption.

91. The system of claim 71, further comprising means for continuously recalculating certificate fingerprints in order to provide an indication of database corruption.

92. The system of claim 81, further comprising means for transmitting by the trade secret accounting system to the trade secret registration system the certificate identifier of the previous certificate with a new request to provide a check of the database integrity to provide an indication of database corruption.

93. The system of claim 81, further comprising means for transmitting by the trade secret registration system to the trade secret accounting system previously granted certificates as a request to verify these certificates and return an indication of their status.

94. The system of claim 81, further comprising:
a) means for continuously recalculating certificate fingerprints in order to provide an indication of database corruption;
b) means for transmitting by the trade secret accounting system to the trade secret registration system the certificate identifier of the previous certificate with a new request to provide a check of the database integrity to provide an indication of database corruption; and
c) means for determining the location of the data corruption from the said return indications.

95. The system of claim 81, further comprising:
a) means for continuously recalculating certificate fingerprints in order to provide an indication of database corruption;
b) means for transmitting by the trade secret registration system to the trade secret accounting system previously granted certificates as a request to verify these certificates and return an indication of their status; and
c) means for determining the location of the data corruption from the said return indications.

96. A method of protecting a trade secret comprising the steps of:
a) applying a plurality of generally accepted legal criteria to a content of the trade secret;
b) assigning a value under each criterion; and
c) generating one or more metrics from the assigned values through the use of logical and mathematical processes, thereby allowing the comparison of results with predetermined threshold values.

97. The method of protecting the trade secret as in claim 96 further comprising creating an application fingerprint from a content of the trade secret.

98. The method of protecting trade secrets as in claim 97 wherein the step of creating the application fingerprint further comprises processing the content of the trade secret using a deterministic one-way algorithm.

99. The method of protecting trade secrets as in claim 97 further comprising transferring the application fingerprint from a creator of the trade secret to a trusted third party.

100. The method of protecting trade secrets as in claim 99 further comprising creating a certificate fingerprint from the application fingerprint by the trusted third party.

101. The method of protecting trade secrets as in claim 100 further comprising transmitting the certificate fingerprint from the trusted third party to the creator of the trade secret as a trade secret certificate.

102. The method of protecting trade secrets as in claim 96 wherein the step of applying the plurality of generally accepted legal criteria further comprises using the six factors of a trade secret as set forth in Section 757 of the First Restatement of Torts.

103. The method of protecting trade secrets as in claim 96 wherein the step of assigning the value further comprises assigning numeric values, such as on a scale of one to five or such as on a scale of zero to ten.

104. The method of protecting trade secrets as in claim 96 wherein the step of generating one or more metrics further comprises comparing the assigned values with predetermined threshold values.

105. An apparatus for protecting a trade secret comprising:
a) means for applying a plurality of generally accepted legal criteria to a content of the trade secret;
b) means for assigning a value under each criterion; and
c) means for generating one or more metrics from the assigned values through the use of logical and mathematical processes, thereby allowing the comparison of results with predetermined threshold values.

106. The apparatus for protecting the trade secret as in claim 105 further comprising means for creating an application fingerprint from a content of the trade secret.

107. The apparatus for protecting trade secrets as in claim 106 wherein the means for creating the application fingerprint further comprises means for processing the content of the trade secret using a deterministic one-way algorithm.

108. The apparatus for protecting trade secrets as in claim 106 further comprising means for transferring the application fingerprint from a creator of the trade secret to a trusted third party.

109. The apparatus for protecting trade secrets as in claim 108 further comprising means for creating a certificate fingerprint from the application fingerprint by the trusted third party.

110. The apparatus for protecting trade secrets as in claim 109 further comprising means for transmitting the certificate fingerprint from the trusted third party to the creator of the trade secret as a trade secret certificate.

111. The apparatus for protecting trade secrets as in claim 105 wherein the means for applying the plurality of generally accepted legal criteria further comprises means for using the six factors of a trade secret as set forth in Section 757 of the First Restatement of Torts.

112. The apparatus for protecting trade secrets as in claim 105 wherein the means for assigning the value further comprises means for assigning numeric values, such as one to five or a scale of zero to ten.

113. The apparatus for protecting trade secrets as in claim 105 wherein the means for generating one or more metrics further comprises means for comparing the assigned values with predetermined threshold values.

114. An apparatus for protecting a trade secret comprising:
a) an information processor adapted to apply a plurality of generally accepted legal criteria to a content of the trade secret;
b) an input device adapted to assign a value under each criterion; and
c) an arithmetic processor adapted to generate one or more metrics from the assigned values through the use of logical and mathematical processes, thereby allowing the comparison of results with predetermined threshold values.

115. The apparatus for protecting the trade secret as in claim 114 further comprising an application processor adapted to create an application fingerprint from a content of the trade secret.

116. The apparatus for protecting trade secrets as in claim 114 further comprising a communication processor adapted to transfer the application fingerprint from a creator of the trade secret to a trusted third party.

117. The apparatus for protecting trade secrets as in claim 116 further comprising a certificate processor adapted to create a certificate fingerprint from the application fingerprint by the trusted third party.

118. The apparatus for protecting trade secrets as in claim 114 wherein the arithmetic processor further comprises a comparator processor adapted to compare the assigned values with predetermined threshold values.
